(19) United States
(12) Patent Application Publication
(10) Pub. No.: US 2012/0064206 A1
(43) Pub. Date: Mar. 15, 2012

(54) NOVEL COATING COMPOSITIONS, USES THEREOF, AND METHOD FOR PREPARING SAME

(75) Inventor: Pierre-Yves Pennarun, Vendome (FR)

(73) Assignee: FROMAGERIES BEL, Paris (FR)

(21) Appl. No.: 13/256,971

(22) PCT Filed: Mar. 15, 2010
(86) PCT No.: PCT/FR2010/050452

§ 371 Date: Oct. 31, 2011

(30) Foreign Application Priority Data
Mar. 17, 2009 (FR) 0951676

(51) Int. Cl. A23C 19/16; C09D 133/10; C09D 191/00; C09D 131/04

(52) U.S. Cl. 426/307; 523/100; 106/270

(57) ABSTRACT

The present invention relates to a composition for coating a food product, particularly cheese, and more particularly firm paste cheese, and in particular pressed paste cheese, including coating wax and a bulking agent.

The present invention relates to a novel coating composition, in particular for cheese. It also relates to a method for preparing said composition, as well as a method for coating food products with said composition and the food products thus coated.

Certain cheeses, particularly firm paste cheese, are packaged in a protective coating in order to prevent, on the one hand, drying of the cheeses during their preservation and marketing, and on the other hand, alteration of the cheese by microorganisms.

With the exception of synthetic plastic-based coatings, of the vinyl acetate polymer type, waxes are the most commonly used coating materials.

Waxes of different origins are used to that end. Oil-origin hydrocarbons waxes are widely used; they are made up of a mixture of paraffins, microcrystalline waxes, and possibly mineral oils. This type of coating as well as its application method are described in patent application FR 1 453 977.

These coating materials must have a plastic and malleable nature, not be brittle, and not adhere to the cheese during elimination when the cheeses are consumed.

Furthermore, they must have melting properties. They are liquid at the coating temperatures of the cheeses by dipping or spraying (40 to 100° C.). They are waxy and solid at ambient temperature, after crystallization of their components.

While the hydrocarbon waxes most commonly used have excellent functional properties and meet all points of the criteria above, they do have an impact on the environment: when they are incinerated or biodegraded (compost), they produce greenhouse gases contributing to global warming. Furthermore, they come from nonrenewable resources, and their price is indexed on the price of the oil from which they result.

Many authors have also sought substitute compounds; these include coatings made up of mono and diglycerides, fatty acids that unfortunately, compared to hydrocarbon waxes, have defects at ambient temperature. These substitute products:
have a lower resistance to impacts,
are sometimes brittle with a tendency toward flaking during elimination when the product is consumed, more particularly when the coating is opened by a pull strip (Tircel); this is all the more true in that one uses a significant fraction of crystalline products at a high melting temperature, such as long-chain fatty acids, for example,
sometimes have an adhesive and fatty nature to the touch for products for example obtained from shorter fatty acids and whereof the temperature is below 40° C.

Although some of these coatings having good plastic properties at ambient temperature, one sees less good behavior of these coatings at higher or lower temperatures that may occur during the distribution cycle of the cheese. Thus, certain products appear too brittle at temperatures around 4° C., while others have a very adhesive nature with the appearance of grease, adhesion to the overpackaging, any migration of coloring agents, or glyceryl components of the packaging.

Fossil-origin wax therefore remains the most interesting solution to date and is therefore the most used.

The present invention aims at providing a coating composition for a food product having satisfactory physicochemical and functional characteristics.

The present invention also aims at providing a coating composition for a food product making it possible to do away with the aforementioned drawbacks relative to hydrocarbon waxes, in particular regarding the costs and harm to the environment.

Thus, the present invention relates to a composition for coating a food product, particularly cheese, and more particularly firm paste cheese, and in particular pressed paste cheese, comprising coating wax and a bulking agent.

This new composition therefore consists in incorporating a bulking agent into the coating waxes, without altering the physicochemical characteristics of the waxes.

In this document, the term “cheese” designates any cheese firm enough to be coated, i.e. having a dry digest greater than 45%, whether resulting from:
a first transformation directly from whole milk, skim milk, or a mixture of the two; the milk being in the form of liquid or reconstituted milk powder, dairy concentrates in the form of liquid or reconstituted powder,
or a second transformation through a rendering process or a method according to patent application FR 2 778 821 or equivalent methods.

The dairy fat can be replaced in whole or in part by vegetable fat.

Cheeses marketed in coatings include pressed paste cheeses such as Gouda, Edam, Cheddar, stringy paste cheeses (e.g. mozzarella), but also firm process cheeses.

Bulking agents are known, such as mineral bulking agents or micronized vegetable fibers used in polymers (for example in “bumpers,” dashboards and other automobile plastics) to reduce the share of nonrenewable materials; the plastic share is decreased, which improves the environmental impact. The bulking agents used are compounds available in nature that contain little or no carbon (mineral bulking agents) or renewable-origin carbon (vegetable, microbic). They are available in significant quantities, which makes their price attractive.

Thus, the present invention is based on tests obtained by the Applicant demonstrating that the impact of the hydrocarbon waxes (cost, environment) is attenuated by incorporating bulking agents (mineral or vegetable origin) in said waxes. It has also been demonstrated that incorporating these bulking agents was applicable to waxes of other origins or to wax substitutes.

In fact, completely unexpectedly, the Applicant has shown that it was possible to incorporate up to 60% bulking agent, in particular in the form of mineral bulking agent, in coating waxes for cheeses, without modifying the following physical characteristics thereof: the melting and crystallization temperatures that condition the coating parameters, as well as the crystallinity level intrinsic to the wax, which is defined by the fraction of compounds in crystalline form present in the final coating. At the same time, it has also shown that, up to bulking agent incorporation levels of 40% by weight, the viscosity was increasing in low enough proportions to still allow cheeses to be coated.

Furthermore, the Applicant has shown that such bulking agents did not significantly modify the mechanical and functional properties of the coating, and these bulking agents did not cause the formation of crevasses or cracks in the coating during cooling, then cold preservation of the product for several weeks. In parallel, it has shown that these bulking agents also did not modify the moisture permeability properties of the material, thereby ensuring the same preservation functions.

Including the bulking agents in the wax leads to an increase in the viscosity of the wax and consequently, to produce coatings whereof the wax weight is equivalent to or lower than the reference, it is necessary to increase the dipping temperature. With an equivalent dipping deposition by weight, the reduction of the wax weight is equal to the bulking agent incorporation level.

All of these properties make it possible to reduce the coating thickness without significantly modifying the coating properties or the coating method. Consequently, the quantity of fossil-origin wax is reduced both by replacing a fraction of the wax and by reducing the thickness.

The composition of the invention preferably comprises the coating wax as the majority component, i.e. it comprises at least 30% by weight, preferably at least 40% by weight, of coating wax.

The coating composition according to the invention is not intended to be dispersed beforehand in an aqueous medium, but applied as such in the melted state on the product. Several layers can be applied several times and the bulking agents are incorporated into at least one of the two coating layers.

Preferably, the coating composition of the present invention does not comprise monoglycerides or diglycerides.

Thus, one preferred composition according to the present invention comprises less than 60% by weight of bulking agent relative to the total weight of said composition. Advantageously, it comprises from 5% to 60%, preferably from 5% to 40%, and preferably from 5% to 30%, by weight of bulking agent relative to the total weight of said composition.

Among the coating waxes used in the context of the present invention, one preferably uses coating waxes whereof the melting temperature is comprised from 35 to 85° C., and in that its viscosity in the melted state is comprised from 5 to 10,000 mPa·s at 100° C., preferably comprised from 5 to 1,000 mPa·s at 100° C., and preferably from 5 to 100 mPa·s.

Preferably, the bulking agents incorporated into the inventive composition have a dimension smaller than 40 μm, and preferably smaller than 30 μm, in order not to be visible after dispersion in the wax.

One advantageous composition according to the present invention is characterized in that the coating wax is chosen from the group consisting of waxes of fossil, vegetable, animal or synthetic origin, wax substitutes, and mixtures thereof.

In the invention, coating wax refers to waxes of fossil or plant origin obtained from renewable or nonrenewable substrates.

Fossil-origin waxes include paraffin waxes and microcrystalline waxes, which are byproducts of the oil industry, but also waxes coming from brown coal (coal); the former are widely used to coat cheeses.

Waxes of plant origin include carnauba waxes, jojoba waxes, etc.

Waxes of animal origin include beeswax.

Waxes of synthetic origin include polyethylene, ester and synthetic amide waxes, waxes obtained using the Fischer-Tropsch method. All of these waxes as well as their characteristics are fully described in Hamilton, R. J.: waxes: chemistry, molecular biology and functions (ED OILY Press—1995, chapter 7).

Coating wax also refers to wax substitutes as they are described for example in patent application EP 0 403 030 (coating made up of mono and diglycerides esterified by different acids), patent application EP 0 679 337 (coating comprising acetylated monoglycerides obtained from long-chain fatty acids (80% stearic and behenic acid)), patent application EP 1 202 634 (coating composition comprising 60 to 100% by weight of an esterification product with at least one fatty acid and at least one branched-chain polyol having at least 4 carbon atoms and 2 OH groups).

The expression “wax substitutes” designates compounds intended for coating, which have the physicochemical and mechanical properties of paraffin and/or monocrystalline waxes. These compounds are essentially obtained from components of renewable origin.

Advantageously, the inventive composition is characterized in that the bulking agent is chosen from among the group consisting of mineral bulking agents, vegetable-origin flours, animal-origin products, synthetic products obtained from renewable resources, and mixtures thereof.

More specifically, “bulking agents” refers to the particles belonging to the families of stones and minerals (mineral bulking agents), vegetable-origin flours, animal-origin products, synthetic products obtained from renewable resources, or combinations of these different bulking agents with each other or with a coating material (encapsulation) to improve their compatibility with the wax. In general, the bulking agents used in the invention are relatively inexpensive.

Mineral bulking agent refers to the mineral compounds essentially belonging to the families of silicates, carbonates, sulfates, chlorides and phosphates.

Examples include carbonates, calcium carbonates, sodium carbonates, potassium carbonates or magnesium carbonates.

The silicate family includes talc (magnesium silicate), kaolin (aluminum silicate), montmorillonite, and other clays.

Examples include sulfate, calcium sulfate.

The chloride family includes sodium, potassium, calcium or magnesium chloride.

These mineral bulking agents have the shared characteristics of being available in large quantities, easily extractable (open-pit or other mines), inert relative to wax and its components, but also relative to the coated product.

“Vegetable-origin flours” refers to the materials micronized and obtained from plants such as wood, fruit shells such as nuts, for example, almonds, lychee, hazelnut. It also refers to the materials making up the plant wall, such as lignin. However, hydrophilic materials of the polysaccharide type such as cellulose, hemicellulose or starch cannot be used as such because they are insoluble in coating waxes due to their hydrophobicity.

Animal products refers for example to polysaccharides of the chitin, chitosan, and calcium carbonate type making up the shell of certain mollusks and crustaceans that are still very poorly developed today after consumption of those foods.

Synthetic products obtained from renewable resources, refers to materials from the plant medium chemically modified or obtained by synthesis from renewable molecules. Examples include polysaccharides modified by chemical grafting (acetylation, fatty acid grafting) for the first family, or, for the second family, molecules with a high melting point or synthetic polymers with a high melting point, such as long fatty acid-based polymers, PLA (polylactic acid) or polyamides obtained from diacids and diamines derived from natural molecules.

One particularly advantageous coating composition according to the invention is a composition as defined above in which the bulking agent is chosen from the group consisting of talc, kaolin, calcium carbonate, sodium chloride, and mixtures thereof. The chosen materials preferably have a low hardness level to be as unaggressive as possible relative to industrial facilities.

One very interesting property shown by the applicant is that the incorporation of these mineral bulking agents (in particular talc or kaolin) reinforces the mechanical structure of the coating. This makes it possible to reduce the thickness of the coating while preserving the proper resistance to impacts during the different manufacturing, packaging (e.g. placement in secondary packaging or grouping together products for small formats) and marketing steps of the product. Moreover, this smaller thickness is favorable to a proper elimination of the coating, in particular using an opening loop during composition.

At the same time, a second property related to the incorporation of certain bulking agents has been shown. In fact, the increase in the viscosity of the melted coating makes it possible to better distribute the coating around the product and consequently to lower the minimum coating thickness needed to preserve the product after packaging.

In the case where the physical compatibility between the bulking agent and the wax is not sufficient to obtain a stable mixture, the coating of said bulking agents with a compatibilizing agent is possible. Thus, the present invention also relates to a coating comprising also comprising a compatibilizing agent. This compatibilizing agent will for example be a compound having surfactant properties (molecule or polymer) such as long-chain hydrogenated fatty acids or their sodium, potassium, calcium or magnesium salts or a polymer having many hydrophilic and hydrophobic functions, such as, for example, a copolymer of ethylene or propylene with methacrylic acid.

Furthermore, in order to prevent the formation of crevasses and the spread of cracks in the coating during cooling, it is advantageously possible to incorporate a polymer (cohesion agent) that serves as a crystallization initiator and to congeal the wax around the product during cooling of the liquid wax. Cohesion agents include the usual polymers: polyvinyl acetate, vinyl acetate and ethylene copolymer, ethylene and butanol methacrylate copolymer, for example, at levels of 0.1 to 5% by weight relative to the total weight of said composition.

The coating compositions according to the invention have physical and functional characteristics (aptitude for coating) close or even identical to those of hydrocarbon wax-based coatings; the crystallization and melting temperatures remain unchanged while the enthalpy of fusion (proportional to the crystallinity rate) decreases in proportion to the bulking agent level. The table below provides the values of the enthalpy of fusion, or energy necessary for melting, of a synthesis wax whereof the components are primarily of vegetable origin, for different kaolin incorporation levels (0, 10, 15, 20, 25, 30, 40, 50, 60%). The granulometry of the kaolin is such that the particles do not exceed 10 μm in diameter and have a median diameter of 2.6 μm.

| | | Enthalpy of fusion of | |
|---|---|---|---|
| Incorporation | Enthalpy of | the wax (J/g, bulking | Comparison vs. |
| (weight %) | fusion (J/g) | agent fraction excluded) | wax alone (%) |
| 0.00 | 93.32 | 93.32 | 100.00 |
| 10.13 | 81.42 | 90.60 | 97.08 |
| 15.02 | 76.96 | 90.56 | 97.04 |
| 20.18 | 74.04 | 92.76 | 99.40 |
| 25.08 | 68.69 | 91.68 | 98.25 |
| 30.78 | 65.66 | 94.86 | 101.65 |
| 40.02 | 55.05 | 91.78 | 98.35 |
| 50.00 | 43.23 | 86.46 | 92.65 |
| 60.00 | 37.10 | 92.75 | 99.39 |

The new coating composition according to the invention is preferably applicable to the coating of cheeses, where it is advantageously substituted for the existing coatings consisting of primarily of mineral waxes (hydrocarbon-based); however, it can be applied to any other food product marketed in a coating.

The invention also relates to the embodiment of the novel coating according to the invention: the method will be adapted as a function of the incorporation level of the bulking agent in the die and the shape of the die before mixing. The method must make it possible to obtain a homogenous mixture in which the bulking agent particles are no longer visible to the naked eye.

The present invention therefore also relates to a method for coating a food product, particularly a cheese, and more particularly a firm paste cheese, and in particular a pressed paste cheese, comprising a step of application on a whole food product or a portion of a food product with a composition as defined above.

According to one particular embodiment, the aforementioned application step consists of a step of soaking the product to be coated in the composition in the viscous state, this dipping step being done in two parts, if applicable. This application step is followed by a step of cooling the coated product, for example by dipping in a solution of ice water.

According to another particular embodiment, the aforementioned application step consists of a step of molding the product to be coated with the composition in the melted and very viscous state, this molding step being followed by a step for cooling the coated product, for example by dipping in an ice water solution.

The present invention also relates to a coated food product, in particular coated cheese, that can be obtained using the coating method as defined above.

The present invention also relates to a method for preparing a composition as defined above, comprising a step of incorporating the bulking agent in the coating wax.

More particularly, the coating wax is heated to a temperature higher than its melting temperature to obtain the wax in the viscous state and the bulking agent is incorporated in the form of micronized particles with said wax in the viscous state under constant agitation until a homogenous mass is obtained, this agitation being done in particular at a temperature below 140° C., and preferably comprised from 75 to 120° C.

Thus, according to one preferred alternative, the method for incorporating the bulking agent in the form of micronized particles after having or not having undergone a treatment making them compatible with incorporation into the die (for example micro-encapsulation) consists of heating the wax to a viscous state, i.e. at a temperature higher than the melting temperature of the components of the wax, adding the bulking agent under constant agitation, and continuing mixing until a homogenous mass is obtained. The agitation will preferably be done between 75 and 120° C., according to the melting and viscosity properties of the wax, and without exceeding 140° C. to avoid damaging the wax, thermally or by oxidation.

The melting temperature of the wax die (35-75° C.) depends on its composition. As an example, the temperature range corresponding to the melting of the microcrystalline wax used for small cheeses is primarily comprised between 35 and 75° C., the paraffin wax used for the same type of product, a more limited melting range, between 35 and 55° C. The incorporation of the bulking agent in the die (wax) can be done on all of the mixers known and used by those skilled in the art; examples include in-line mixers allowing an easy and continuous incorporation of the bulking agent in the die. Examples include the Silverson® or Ystral® high shear in-line mixers.

One advantageous embodiment of the method for preparing the composition according to the invention consists of preparing micronized particles of bulking agent and having them undergo a treatment prior to their incorporation in the coating wax.

Preferably, said prior treatment of the micronized particles consists of adding an additive to them or encapsulating them in a material compatible with the physicochemical properties of the wax die.

Of course, the bulking agent compounds can be used in the die consisting of a coating wax, alone or in a mixture. These mineral bulking agents are used after micronization to obtain to obtain particles with a size smaller than 40 μm either in their current state, or after having undergone a treatment making them compatible with incorporation in the die (wax) if they are not; treatment methods in particular include the addition of additives (fatty acid salts, copolymers having surfactant properties, wax or paraffin, etc.) or encapsulation, such as microencapsulation. As an example, sodium chloride, known for its hydrophilic properties (therefore incompatible with wax), must be microencapsulated beforehand, for example, by wax with a high melting point (90-120° C.) to make it compatible with the wax in which it will be incorporated. As micro-encapsulation technique, it is possible to use the fluid bed that consists of vaporizing the liquid wax on bulking agent particles suspended in a gas stream.

The invention will be illustrated through examples provided for information and non-limitingly.

In a first step, a control is made by coating a cheese with 30 g of pressed paste with a first layer of microcrystalline wax and a second layer of colored paraffin wax; this control is produced as follows: the cheeses are made using a traditional method for manufacturing pressed paste (ex: method described in Eck:Le Fromage Ed Lavoisier Paris 1997); after brining, they are wiped before undergoing the coating step. The temperature of these products is near 5 to 8° C. at the beginning of the dipping process, in the first wax bath. The dipping temperature in the microcrystalline wax is set at 80° C., and that of the standard paraffin wax at 71° C. After successive dipping in these two waxes, the product is cooled in an ice water bath before being wrapped in a cellophane paper. This paper is heat sealed on itself before packaging of the cheeses in a secondary packaging. The weight of each layer of wax is 5.0 g.

In parallel, cheeses are prepared using the same method and they are coated with different formulations of microcrystalline and paraffin wax charged with different levels of kaolin or talc according to the table below; the table also presents the corresponding dipping temperatures and the wax weights actually deposited:

| Bulking agent | | | | | | | | |
|---|---|---|---|---|---|---|---|---|
| % in micro- | | Dipping | Weight of | Bulking | | Dipping | Weight of | Total |
| crystalline (A) | | tempera- | wax A on | agent % in | | tempera- | wax B on | weight on |
| (bulking agent | | ture in wax | the | paraffin | | ture in wax | the | the |
| nature) | | A (° C.) | cheese | wax (B) | | B (° C.) | cheese | cheese |
| 0 | | 80 | 2.40 | 0 | | 71 | 2.60 | 5.00 |
| 15 | (kaolin) | 100 | 2.30 | 15 | (kaolin) | 82 | 2.50 | 4.8 |
| 15 | (kaolin) | 105 | 2.20 | 15 | (kaolin) | 86 | 2.35 | 4.55 |
| 15 | (talc) | 100 | 2.30 | 15 | (talc) | 82 | 2.50 | 4.8 |
| 15 | (talc) | 105 | 2.20 | 15 | (talc) | 86 | 2.35 | 4.55 |

| | | | | | | | |
|---|---|---|---|---|---|---|---|
| 0 | 95 | 2.20 | 15 | (talc) | 82 | 2.50 | 4.70 |
| 0 | 95 | 2.20 | 15 | (talc) | 86 | 2.35 | 4.55 |

Examples of viscosities reached with bulking agent levels of 20% and 30% by weight of talc in a colored paraffin wax are given below for a temperature of 70° C. These values are obtained on a HAAKE RS 100 rheometer with a DG41 double gap geometry (air gap of 5.1 mm).

| | Paraffin | | |
|---|---|---|---|
| | wax (ref) | Wax + 20% talc | Wax + 30% talc |
| Viscosity at 70° C. | 23 | 45 | 97 |
| (mPa · s) | | | |

The viscosities reached, including for a bulking agent level of 30%, still make it possible to produce a coating. To that end, as shown in the first table, increasing the dipping temperature makes it possible to offset the increase in the viscosity.

The wax weight is then reduced both by adding bulking agent and reducing the thickness, which is economically and ecologically interesting.

1. A composition for coating a food product, particularly cheese, and more particularly firm paste cheese, and in particular pressed paste cheese, comprising coating wax and a bulking agent.

2. The composition according to claim 1, characterized in that it comprises less than 60% by weight of bulking agent relative to the total weight of said composition, and advantageously from 5% to 60%, preferably from 5% to 40%, and preferably from 5% to 30%, by weight of bulking agent relative to the total weight of said composition.

3. The composition according to claim 1, characterized in that the melting temperature of the coating wax is comprised from 35 to 85° C., and in that its viscosity in the melted state is comprised from 5 to 10,000 mPa·s at 100° C., preferably comprised from 5 to 1,000 mPa·s at 100° C., and preferably from 5 to 100 mPa·s.

4. The composition according to claim 1, characterized in that the bulking agent has a dimension smaller than 40 μm, and preferably smaller than 30 μm.

5. The composition according to claim 1, characterized in that the coating wax is chosen from the group consisting of waxes of fossil, vegetable, animal or synthetic origin, wax substitutes, and mixtures thereof.

6. The composition according to claim 1, characterized in that the bulking agent is chosen from among the group consisting of mineral bulking agents, vegetable-origin flours, animal-origin products, synthetic products obtained from renewable resources, and mixtures thereof, and preferably in that the bulking agent is chosen from among the group consisting of talc, kaolin, calcium carbonate, sodium chloride, and mixtures thereof.

7. The composition according to claim 1, also comprising a compatibilizing agent, in particular chosen from among compounds having surfactant properties or polymers having hydrophilic and hydrophobic functions.

8. The composition according to 1, also comprising a cohesion agent, in particular chosen from among the group consisting of polyvinyl acetate, vinyl acetate and ethylene copolymer, ethylene and butanol methacrylate copolymer, said content level by weight of the cohesion agent preferably being comprised from 0.1% to 5% by weight relative to the total weight of said composition.

9. A method for coating a food product, in particular a cheese, and more particularly firm paste cheese, and in particular pressed paste cheese, comprising a step of application on a whole food product or a portion of a food product of a composition according to claim 1.

10. The coating method according to claim 9, characterized in that the application step is a step of soaking the product to be coated in the composition in the viscous state, this dipping step being done in two parts if necessary, and in that the application step is followed by a step of cooling the coated product, for example by dipping in a solution of ice water.

11. The coating method according to claim 9, characterized in that the application step is a step of molding the product to be coated with the composition in the melted and very viscous state, and in that said molding step is followed by a step of cooling the coated product, for example by dipping in an ice water solution.

12. A coated food product, in particular coated cheese, that can be obtained using the coating method according to claim 9.

13. A method for preparing a composition according to claim 1, comprising a step of incorporating the bulking agent in the coating wax.

14. The method according to claim 13, characterized in that the coating wax is heated to a temperature higher than its melting temperature to obtain the wax in the viscous state and in that the bulking agent is incorporated in the form of micronized particles with said wax in the viscous state under constant agitation until a homogenous mass is obtained, this agitation being done in particular at a temperature below 140° C., and preferably comprised from 75 to 120° C.

15. The method according to claim 13, characterized in that the micronized particles of bulking agent undergo prior treatment before being incorporated into the coating wax, said prior treatment of the micronized bulking agent particles preferably consisting of adding an additive to them or encapsulating them in a material compatible with the physicochemical properties of the wax die.
